(19) United States
(12) Patent Application Publication
(10) Pub. No.: US 2005/0269349 A1
(43) Pub. Date: Dec. 8, 2005

(54) Center tab bags and dispensers for same providing easy load features

(76) Inventor: Mark E. Daniels, Rolling Hills Estates, CA (US)

Correspondence Address: BELASCO, JACOBS & TOWNSLEY LLP;HOWARD HUGHES CENTER, 6100 CENTER DRIVE, SUITE 630, LOS ANGELES, CA, 90045, US

(21) Appl. No.: 10/861,933

(22) Filed: Jun. 4, 2004

(51) Int. Cl. B65H 1/00; B65D 33/00; B65G 59/00

(52) U.S. Cl. 221/282

(57) ABSTRACT

A plastic bag and dispenser combination providing easy loading features includes a plurality of bags, each having at least one center tab with a central opening. The tabs are either designed to tear from the bags upon dispensing or to rupture, remaining with the dispensed bag. The dispenser has a downward pointing projection that fits through the opening in the tabs, and a support bar fixed horizontally above the projection. When bags are suspended from the projection at the tabs and located over the support bar, they are ready for individual dispensing. The combination is also applied to T-shirt style bags. The dispenser may be easily loaded as at least one end of the support bar is unattached and the bags may be slipped behind it. Variants of the invention include different configurations of the dispenser for attachment to vertical and horizontal surfaces, under shelves and to other bag dispensers.

### FIELD OF INVENTION

The invention pertains to plastic bags and related dispensers. More particularly, the invention relates to expandable plastic film bags having and central mounting tabs and dispensers for stacks of such bags.

### BACKGROUND OF THE INVENTION

Various styles of grocery, produce merchandise bags and related dispensers are commonly found in modern grocery stores, supermarkets, fast food outlets and department stores. Plastic bags are typically dispensed either from rolls or from bag packs. Dispensers using bag packs are desirable in that they can be refilled when only partially empty without wasting any bags. In contrast, dispensers using bag rolls must await exhaustion of the bag roll or cause a portion of the roll to be wasted in order to have the dispenser refilled. On the down side, pack type bag dispensers that can easily and efficiently dispense bags from a bag pack are often difficult and time consuming to load. Because of this difficulty, it is possible to drop all or part of a bag pack when loading the dispenser. As the cost for floor space in stores increases in price, bag dispensing systems that can be fitted into otherwise unusable space become very desirable. Dispenser that can be positioned under counters, on walls, or over otherwise unused space often provide ergonomics that make efficient use of available space while providing bags close at hand to check-out personnel or customers. The present invention addresses these difficulties while taking advantage of the dispensing features of bag pack type dispensers.

Various methods and systems have been developed for dispensing and opening plastic bags, incorporating a number of different technologies. U.S. Pat. No. RE35,207 issued to Daniels, the present inventor, is directed to a directed to a method of and means for dispensing shopping bags from different sized bag packs. A rack for holding and dispensing three same or different sized packs of T-shirt style bags is illustrated. The rack comprises a transverse plate adapted to be mounted on a vertical or horizontal surface. Welded to the ends of plate is a U-shaped wire member resembling a towel bar. A vertical hook supporting plate is secured at the center of the plate to extend downwardly so as to support spaced apart wire hooking elements. Bags are installed by slipping the bag pack over the transverse bar portion of the U-shaped member and between that member and the plate. Strap ends are brought down below the hooking element whereby it is passed through a slot in a detachable closure of the bags.

U.S. Pat. No. 4,830,317 issued to Kober et al., is directed to an automatic T-shirt rack/bag system that has a retaining bar to hold the T-shirt bag handles. The stack of bags is hung over a rear wall with the T-shirt handles draped over the rear of the vertical wall. Preferably the bag holding wall also includes a retaining bar, which is biased against the draped, handles by, for example, bar holding slots located on either side of the vertical wall.

U.S. Pat. No. 5,584,402 issued to Johnson, discloses a bag storage and dispensing rack that can be mounted on a shelf or suspended under a horizontal surface. A rack for storing and dispensing a stack of bags is illustrated. The rack comprises a base member and a tray member. The base member has tracks that are adapted to receive projections of the tray, allowing the tray to slide on the base member out from under the counter to allow a bag stored on the tray to be dispensed. The base is mounted on the shelf by means of brackets. The rack is mounted from a vertical support surface or wall of a counter. The base member is supported on a pair of brackets. A mounting technique is shown where the base member is suspended from a horizontal surface utilizing brackets.

U.S. Pat. No. 4,858,862 issued to Prader, describes an apparatus for suspending bag packs of different geometry. The apparatus comprises a frame with a handle holder at the front of the frame. A first type of bag pack has a handle cross member. This bag pack is supported by placing the bridging portion in back of a post member with the handles of the bag pack draped over the end regions of handle holder. A bag pack of a second geometry is also illustrated. The bags have tabs that are engaged over a support means. Thereafter, the handles of the bag pack are folded over the top and behind the end regions of the handle holder.

U.S. Pat. No. 5,092,548, issued to Bayess et al. is directed to a device for holding T-shirt bags. The device has a mounting plate, which may be attached to a horizontal surface beneath a countertop, or to a vertical surface such as a wall. A U-shaped extension bar extends from the mounting plate. Attached to the U-shaped bar is a shoulder supporting bar. A bag separating member is attached to both the midpoint of both the supporting bar and the U-shaped bar. An assembly of bags is placed onto the device by placing the bag attachment loop over the separating member and allowing the bags to hang. The shoulders of the bags are draped over first and second sub-sections of the bag supporting bar.

While other variations exist, the above-described designs for dispensers for roll mounted bags are typical of those encountered in the prior art.

It is an objective of the present invention to provide a bag and dispenser combination that can be refilled at any time without waste of bags. It is another objective to provide a bag that readily identifies the openable end to the user. It is a further objective of the invention to provide a bag and dispenser combination that prevents the user from grasping multiple bags when using the dispenser. It is still a further objective to provide a dispensing system that can take advantage of the limited spaces available around a check-out station or display to provide easy and ergonomic access to bags. Finally, it is an objective of the invention to provide a system that opens the bags as they are removed from the dispenser.

While some of the objectives of the present invention are disclosed in the prior art, none of the inventions found include all of the requirements identified. The present invention addresses many of the deficiencies of prior art roll mounted bags and dispensers and satisfies all of the objectives described above.

### SUMMARY OF THE INVENTION

(1) A bag and dispenser combination providing the desired features may be constructed from the following components. A plurality of plastic bags is provided. Each of the bags has a front wall, a rear wall, first and second parallel linear side edges, a first predetermined width, front and rear top edges, an openable mouth and a bottom edge. The front and rear walls have at least one front tab or rear tab. The tab is located at at least one of the top edges and has an opening therethrough. The opening is sized, shaped and located for suspending the bag from a dispenser.

A dispenser is provided. The dispenser includes a downward pointing projection. The projection is sized and shaped to fit slidably through the opening in the tab. A support bar is provided. The support bar has first and second ends and is located horizontally above the projection. When the plurality of bags are suspended from the projection at the tab and located over the support bar, the bags will be positioned for individual dispensing.

(2) In a variant of the invention, the bag is a T-shirt style bag that includes a front panel. The front panel has first and second parallel linear side edges, a top edge and a bottom edge. A rear panel is provided. The rear panel has first and second parallel linear side edges, a top edge and a bottom edge. Two front gusset panels of a first predetermined dimension are provided. Each front gusset panel has a top edge, a bottom edge, first and second parallel side edges. Each front gusset panel is joined at the first side edge to one of the linear side edges of the front panel and extends from the top edge of the front panel to the bottom edge of the front panel.

Two rear gusset panels of the first predetermined dimension are provided. Each rear gusset panel has a top edge, a bottom edge, first and second parallel side edges and is joined at the first side edge to one of the linear side edges of the rear panel and extends from the top edge of the rear panel to the bottom edge of the rear panel. Each front gusset panel also is joined to a respective one of the rear gusset panels at the second side edge.

Each of the front and rear gusset panels is folded inwardly relative to the front and the rear panels. The top edges of the front panel, the rear panel, the front gusset panels and the rear gusset panels terminate in an upper seam. The bottom edges of the front panel, the rear panel, the front gusset panels and the rear gusset panels terminate in a lower seam. The lower seam is perpendicular to the linear side edges of the front and rear panels. A U-shaped cut-out is provided. The U-shaped cut-out is located in an upper portion of the bag and begins at a first point along the upper seam spaced inwardly from the first linear side edge and extends to a second point along the upper seam spaced inwardly from the second linear side edge. The cut-out extends downwardly toward the lower seam, thereby forming an openable mouth and a pair of bag handles, the tab is centrally located on an edge of the openable mouth.

(3) In another variant, the tab is attached to the openable mouth using a cut line such that as the bag is pulled from the dispenser, the tabs will be torn from the bag mouth and remain on the projection.

(4) In still another variant, the tab includes a rupturable feature. The rupturable feature connects to the opening and extends toward a perimeter of the tab. When the bag is pulled from the dispenser, the rupturable feature provides a connection between the opening and the perimeter, permitting the bag to be removed from the projection without leaving a portion of the tabs on the projection.

(5) In a further variant, the bags include means for removably attaching an upper portion of the rear panel of a first bag to an upper portion of the front panel of a second, adjacent registered bag. When the first bag is pulled from the dispenser, the rear panel will pull the front panel of the second bag forward, causing the second bag to open.

(6) In still a further variant, the means for removably attaching the upper portion of the rear panel of the first bag to the upper portion of the front panel of the second, adjacent registered bag is selected from the group that includes glue spotting, corona treatment, hot pinning, cold staking and compression.

(7) In another variant of the invention, the projection includes a downward facing hook.

(8) In yet another variant, the downward facing hook includes a rounded feature at a lower end of the hook. The rounded feature is designed to prevent injury and unwanted tearing of the bag tabs.

(9) In still another variant, the support bar has a length greater than the first predetermined width.

(10) In a further variant, the support bar has bag control features located at the first and second ends.

(11) In still a further variant, the bag control features comprise upwardly angled include projections. The projections are sized, shaped and located to prevent lateral movement of the bags.

(12) In yet a further variant, the bag control features include rounded ends. The rounded ends are sized, shaped and located to prevent lateral movement of the bags.

(13) In another variant of the invention, a tab stop is provided. The tab stop is mounted to the downward pointing projection above a lower end of the projection and prevents upward movement of bag tabs beyond the tab stop.

(14) In still another variant, the support bar is attached at the second end to a spacing bracket. The spacing bracket locates the support bar at a first predetermined distance outward from the bracket such that a bag pack will fit slidably between the bracket and the support bar.

(15) In a further variant, the downward pointing projection is attached to the spacing bracket.

(16) In still a further variant, the downward pointing projection is attached to the support bar.

(17) In yet a further variant, the dispenser includes a mounting fixture. The mounting fixture is attached to the spacing bracket.

(18) In another variant of the invention, the bag and dispenser combination includes at least one additional downward pointing projection. The additional projection is located below the projection.

(19) In still another variant, the additional projection extends outwardly toward the support bar further than the projection.

(20) In yet another variant, the support bar is attached at the second end to a horizontal surface mount and the downward pointing projection is attached to the support bar.

(21) In a further variant, the support bar is attached at the second end to a vertical surface mount and the downward pointing projection is attached to the support bar.

(22) In still a further variant, the support bar is attached at the second end to another bag dispenser.

(23) In yet an further variant, the spacing bracket is attached to another bag dispenser.

(24) In another variant, a U-shaped bracket is provided. The bracket has a first vertical side, a second vertical side spaced from the first side and a connecting lower portion. The first vertical side has features for attaching the vertical side to a vertical surface. The support bar is attached orthogonally to an upper end of the second vertical side. The downward pointing projection is attached to the second vertical side at a point spaced downwardly from the support bar.

(25) In yet another variant, the spacing bracket is attached to an L-shaped bracket. The L-shaped bracket extends above or below the support bar and has at least one hole through it for attachment to a horizontal surface.

(26) In still another variant of the invention, the support bar is centrally attached to a vertical member. The vertical member is attached at a lower end to a base for securing the dispenser to a horizontal surface. The vertical member has at least one of the downward pointing projections attached to its front surface.

(27) In yet a further variant, the spacing bracket is attached to a vertical support. The vertical support is attached at a lower end to a base.

(28) In still a further variant, a reinforcing section is provided. The reinforcing section is attached to the support bar at a first end and attached to the vertical support at a second end.

(29) In another variant of the invention, the base is sized and shaped to secure the dispenser to either a horizontal surface or a vertical surface.

(30) In a final variant, the base is sized and shaped to secure the dispenser to a railing.

An appreciation of the other aims and objectives of the present invention and an understanding of it may be achieved by referring to the accompanying drawings and the detailed description of a preferred embodiment.

### DESCRIPTION OF THE DRAWINGS

FIG. 1 is a perspective view of a pack of center tab bags with rupturable tab opening;

FIG. 2 is a perspective view of a pack of T-shirt style bags with removable tab;

FIG. 3 is a perspective view of a pack of T-shirt style bags with removable tab illustrating means for attaching the bag walls together;

FIG. 4 is a perspective view of a pack of center tab bags with rupturable tab opening and center handle opening;

FIG. 5 is a perspective view of a first embodiment of the dispenser of the invention illustrating a support bar attached at a second end to a spacing bracket and having two downward pointing projections for attachment to bag tab openings;

FIG. 6 is a perspective view of another alternate embodiment of the dispenser illustrating a support bar having bag control features at its first and second ends and illustrating a method of loading bags into the dispenser;

FIG. 7 is a perspective view of another alternate embodiment of the dispenser illustrating a support bar attached at one end to a horizontal surface mount;

FIG. 8 is a perspective view of another alternate embodiment of the dispenser illustrating a support bar attached at one end to a vertical surface mount;

FIG. 9 is a perspective view of another alternate embodiment of the dispenser illustrating a support bar attached at a second end to a spacing bracket and a tab stop attached to the downward pointing projection;

FIG. 10 is a perspective view of another alternate embodiment of the dispenser attached at the spacing bracket to a side of another bag dispenser;

FIG. 11 is a perspective view of another alternate embodiment of the dispenser suitable for mounting under a counter;

FIG. 12 is a perspective view of another alternate embodiment of the dispenser illustrating a vertical surface mount and downward pointing projection attached to the mount;

FIG. 13 is a perspective view of another alternate embodiment of the dispenser attached at the second end of the support bar to a side of another bag dispenser;

FIG. 14 is a perspective view of another alternate embodiment of the dispenser with the support bar attached at an upper end of a U-shaped bracket attached to a vertical surface; and

FIG. 15 is a perspective view of another embodiment of a dispenser with the spacing bar attached to a vertical support.

### DETAILED DESCRIPTION OF THE PREFERRED EMBODIMENT

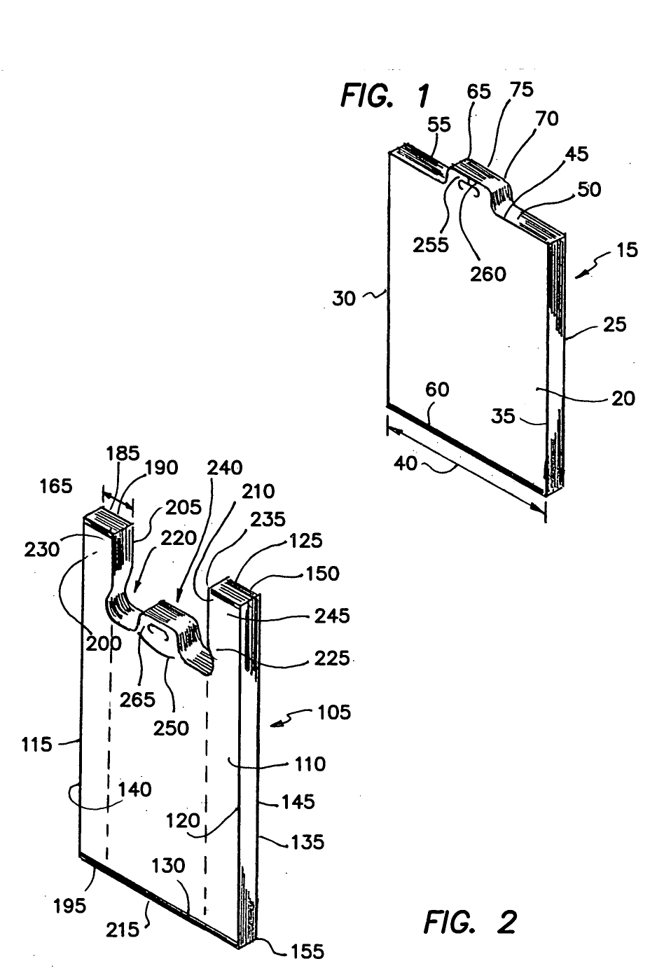

(1) FIGS. 1, 4 and 6 illustrate a bag and dispenser combination 10 providing the desired features that may be constructed from the following components. As illustrated in FIGS. 1 and 4, a plurality of plastic bags 15 is provided. Each of the bags 15 has a front wall 20, a rear wall 25, first 30 and second 35 parallel linear side edges, a first predetermined width 40, front 45 and rear 50 top edges, an openable mouth 55 and a bottom edge 60. The front 20 and rear 25 walls have at least one front tab 65 or rear tab 70. The tab 65, 70 is located at at least one of the top edges 45, 50 and has an opening 75 therethrough. The opening 75 is sized, shaped and located for suspending the bag 15 from a dispenser 80.

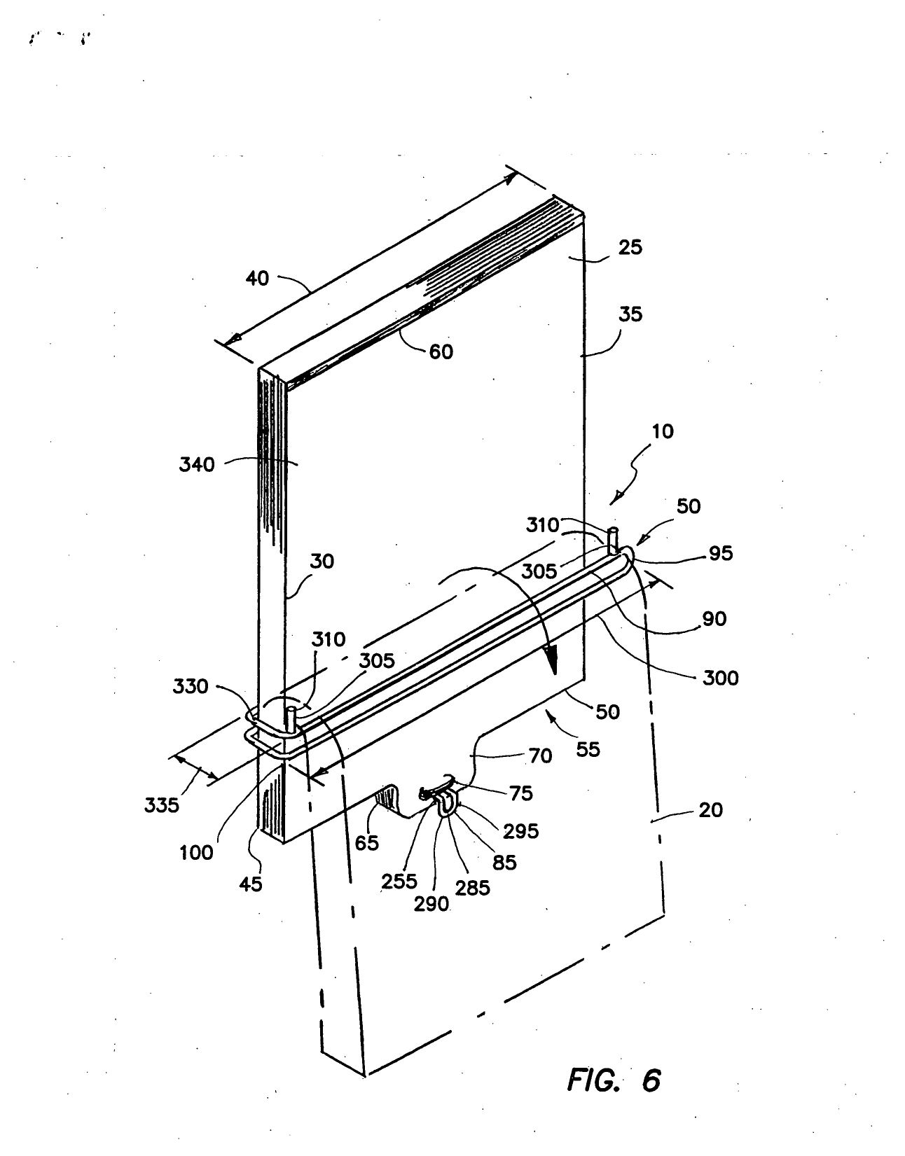

As illustrated in FIG. 6, a dispenser 80 is provided. The dispenser 80 includes a downward pointing projection 85. The projection 85 is sized and shaped to fit slidably through the opening 75 in the tab 65, 70. A support bar 90 is provided. The support bar 90 has first 95 and second 100 ends and is located horizontally above the projection 85. When the plurality of bags 15 are suspended from the projection 85 at the tab 65, 70 and located over the support bar 90, the bags 15 will be positioned for individual dispensing.

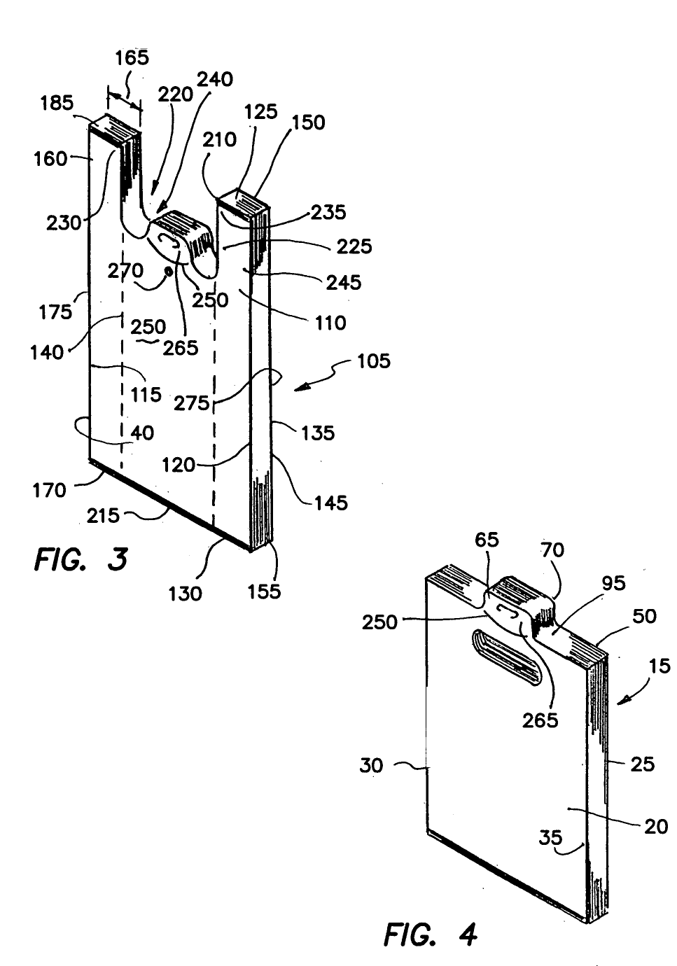

(2) In a variant of the invention, as illustrated in FIGS. 2 and 3, the bag 15 is a T-shirt style bag 105 that includes a front panel 110. The front panel 110 has first 115 and second 120 parallel linear side edges, a top edge 125 and a bottom edge 130. A rear panel 135 is provided. The rear panel 135 has first 140 and second 145 parallel linear side edges, a top edge 150 and a bottom edge 155. Two front gusset panels 160 of a first predetermined dimension 165 are provided. Each front gusset panel 160 has a top edge 165, a bottom edge 170, first 175 and second 180 parallel side edges. Each front gusset panel 160 is joined at the first side edge 175 to one of the linear side edges 115, 120 of the front panel 110 and extends from the top edge 125 of the front panel 110 to the bottom edge 130 of the front panel 110.

Two rear gusset panels 185 of the first predetermined dimension 165 are provided. Each rear gusset panel 185 has a top edge 190, a bottom edge 195, first 200 and second 205 parallel side edges and is joined at the first side edge 200 to one of the linear side edges 140, 145 of the rear panel 135 and extends from the top edge 150 of the rear panel 135 to the bottom edge 155 of the rear panel 135. Each front gusset panel 160 also is joined to a respective one of the rear gusset panels 185 at the second side edge 180, 205.

Each of the front 160 and rear 185 gusset panels is folded inwardly relative to the front 110 and the rear 135 panels. The top edges 125, 150, 165, 190 of the front panel 110, the rear panel 135, the front gusset panels 160 and the rear gusset panels 185 terminate in an upper seam 210. The bottom edges 130, 155, 170, 195 of the front panel 110, the rear panel 135, the front gusset panels 160 and the rear gusset panels 185 terminate in a lower seam 215. The lower seam 215 is perpendicular to the linear side edges 115, 120, 140, 145 of the front 110 and rear 135 panels. A U-shaped cut-out 220 is provided. The U-shaped cut-out 220 is located in an upper portion 225 of the bag 105 and begins at a first point 230 along the upper seam 210 spaced inwardly from the first linear side edge 115, 140 and extends to a second point 235 along the upper seam 210 spaced inwardly from the second linear side edge 120, 145. The cut-out 220 extends downwardly toward the lower seam 215, thereby forming an openable mouth 240 and a pair of bag handles 245, the tab 65, 70 is centrally located on an edge of the openable mouth 240.

(3) In another variant, as illustrated in FIGS. 2-4, the tab 65, 70 is attached to the openable mouth 55, 240 using a cut line 250 such that as the bag 15, 105 is pulled from the dispenser 80, the tabs 65, 70 will be torn from the bag mouth 240 and remain on the projection 85.

(4) In still another variant, as illustrated in FIGS. 1 and 6, the tab 65, 70 includes a rupturable feature 255. The rupturable feature 255 connects to the opening 75 and extends toward a perimeter 260 of the tab 65, 79. When the bag 15, 105 is pulled from the dispenser 80, the rupturable feature 255 provides a connection between the opening 75 and the perimeter 260, permitting the bag 15, 105 to be removed from the projection 85 without leaving a portion 265 of the tabs 65, 70 on the projection 85, as illustrated in FIGS. 2-4.

(5) In a further variant, as illustrated in FIG. 3, the bags 105 include means 270 for removably attaching an upper portion 275 of the rear panel 135 of a first bag 105 to an upper portion 280 of the front panel 110 of a second, adjacent registered bag 105. When the first bag 105 is pulled from the dispenser 80, the rear panel 135 will pull the front panel 110 of the second bag 105 forward, causing the second bag 105 to open.

(6) In still a further variant, the means 270 for removably attaching the upper portion 275 of the rear panel 135 of the first bag 105 to the upper portion 280 of the front panel 110 of the second, adjacent registered bag 105 is selected from the group that includes glue spotting, corona treatment, hot pinning, cold staking and compression.

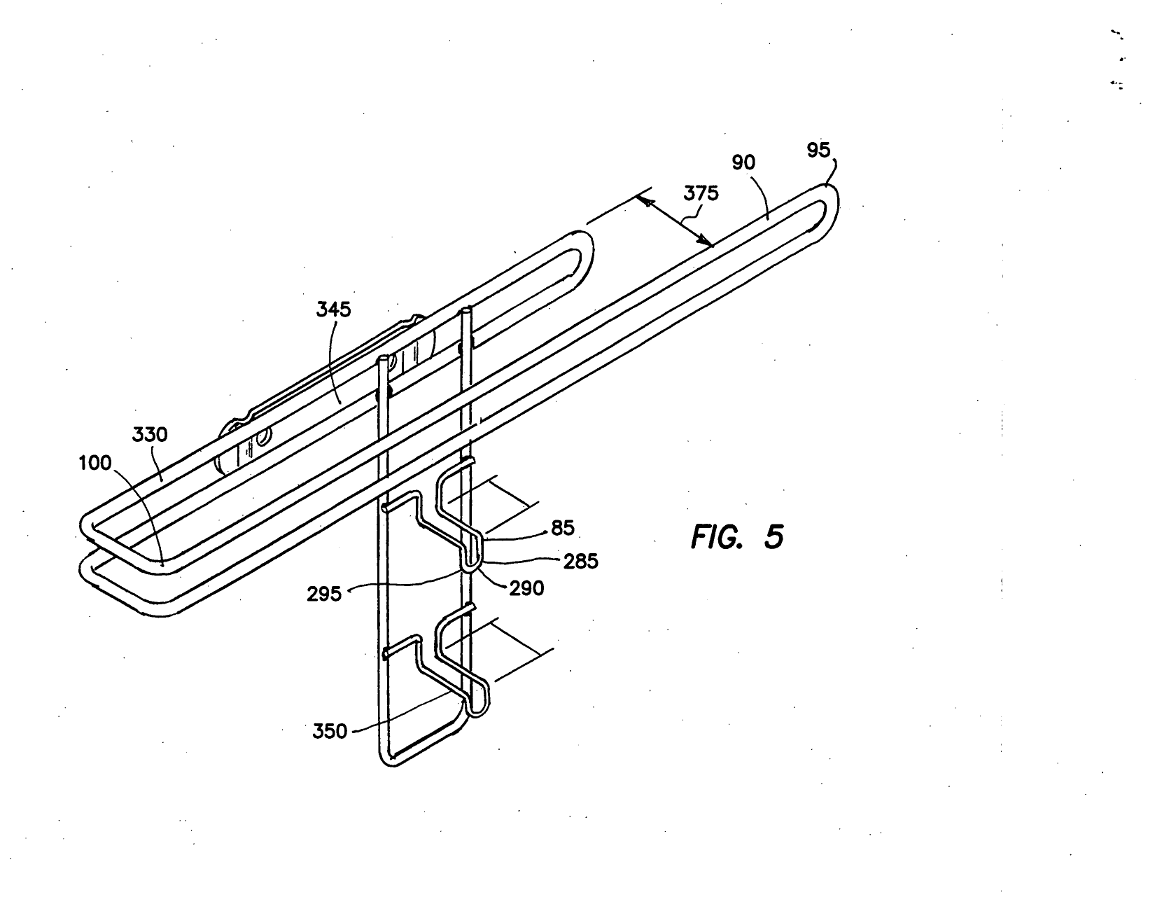

(7) In another variant of the invention, as illustrated in FIGS. 5-12, the projection 85 includes a downward facing hook 285.

(8) In yet another variant, the downward facing hook 285 includes a rounded feature 290 at a lower end 295 of the hook 285, the rounded feature 290 is designed to prevent injury and unwanted tearing of the bag tabs 65, 70.

(9) In still another variant, as illustrated in FIG. 6, the support bar 90 has a length 300 greater than the first predetermined width 40.

(10) In a further variant, as illustrated in FIG. 6, the support bar 90 has bag control features 305 located at the first 95 and second 100 ends.

(11) In still a further variant, as illustrated in FIG. 6, the bag control features 305 include upwardly angled projections 310. The projections 310 are sized, shaped and located to prevent lateral movement of the bags 15, 105.

(12) In yet a further variant, as illustrated in FIG. 8, the bag control features 305 include rounded ends 315. The rounded ends 315 are sized, shaped and located to prevent lateral movement of the bags 15, 105.

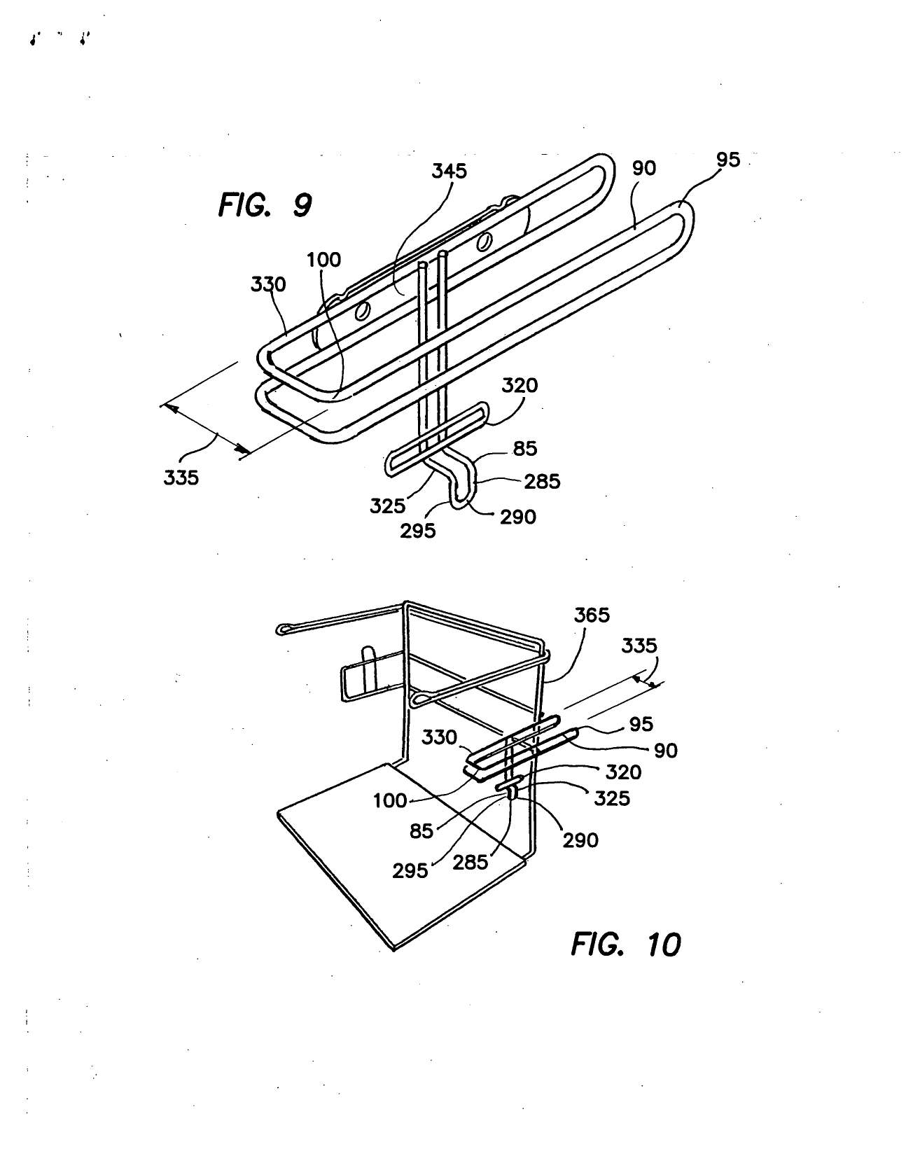

(13) In another variant of the invention, as illustrated in FIGS. 9-11, a tab stop 320 is provided. The tab stop 320 is mounted to the downward pointing projection 85 above a lower end 325 of the projection 85 and prevents upward movement of bag tabs 65, 70 beyond the tab stop 320.

(14) In still another variant, as illustrated in FIGS. 5, 6, 9, 10 and 11, the support bar 90 is attached at the second end 100 to a spacing bracket 330. The spacing bracket 330 locates the support bar 90 at a first predetermined distance 335 outward from the bracket 330 such that a bag pack 340 will fit slidably between the bracket 330 and the support bar 90.

(15) In a further variant, as illustrated in FIGS. 5, 6, 9 and 10, the downward pointing projection 85 is attached to the spacing bracket 330.

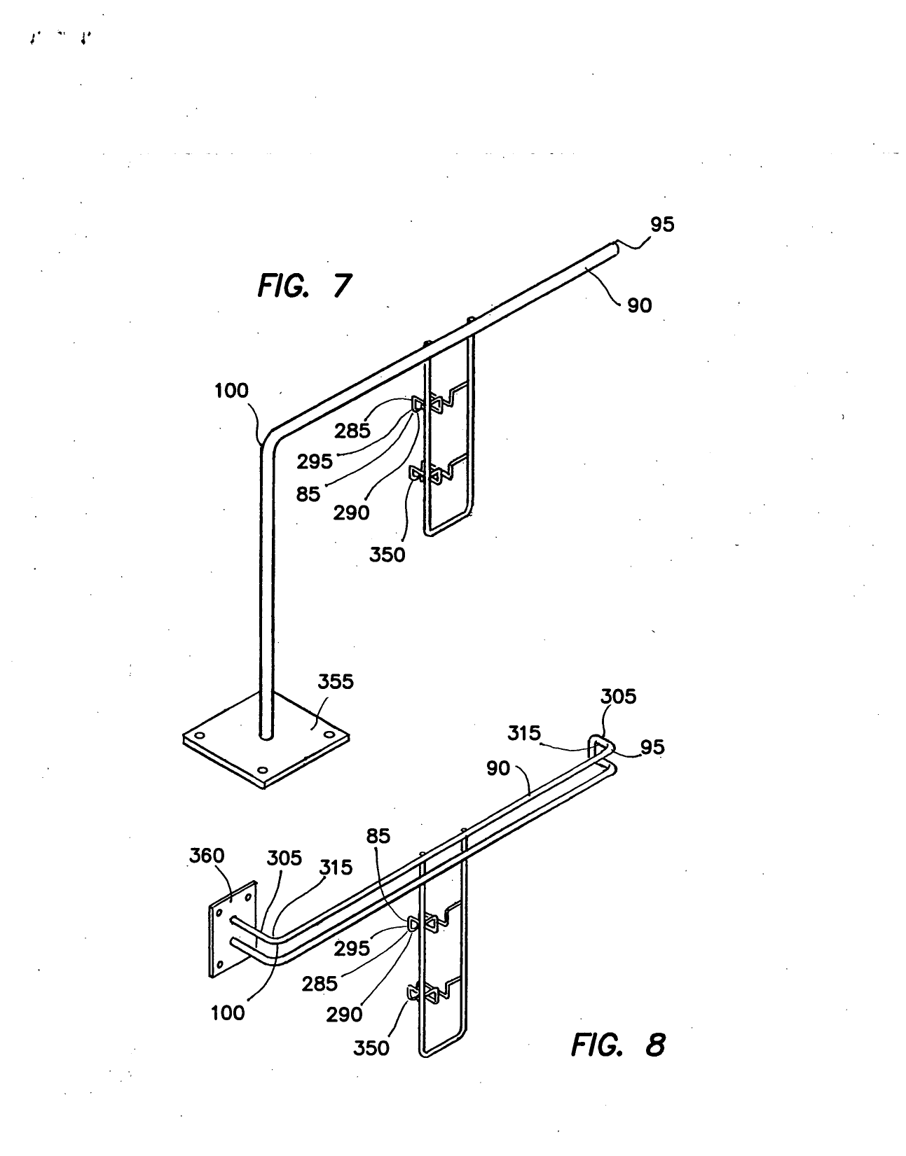

(16) In still a further variant, as illustrated in FIGS. 7 and 8, the downward pointing projection 85 is attached to the support bar 90.

(17) In yet a further variant, as illustrated in FIGS. 5, 9 and 11, the dispenser 80 includes a mounting fixture 345. The mounting fixture 345 is attached to the spacing bracket 330.

(18) In another variant of the invention, as illustrated in FIGS. 5, 7, 8 and 12, the bag and dispenser combination 10 includes at least one additional downward pointing projection 350. The additional projection 350 is located below the projection 85.

(19) In still another variant, as illustrated in FIG. 5, the additional projection 350 extends outwardly toward the support bar 90 further than the projection 85.

(20) In yet another variant, as illustrated in FIG. 7, the support bar 90 is attached at the second end 100 to a horizontal surface mount 355 and the downward pointing projection 85 is attached to the support bar 90.

(21) In a further variant, as illustrated in FIG. 8, the support bar 90 is attached at the second end 100 to a vertical surface mount 360 and the downward pointing projection 85 is attached to the support bar 90.

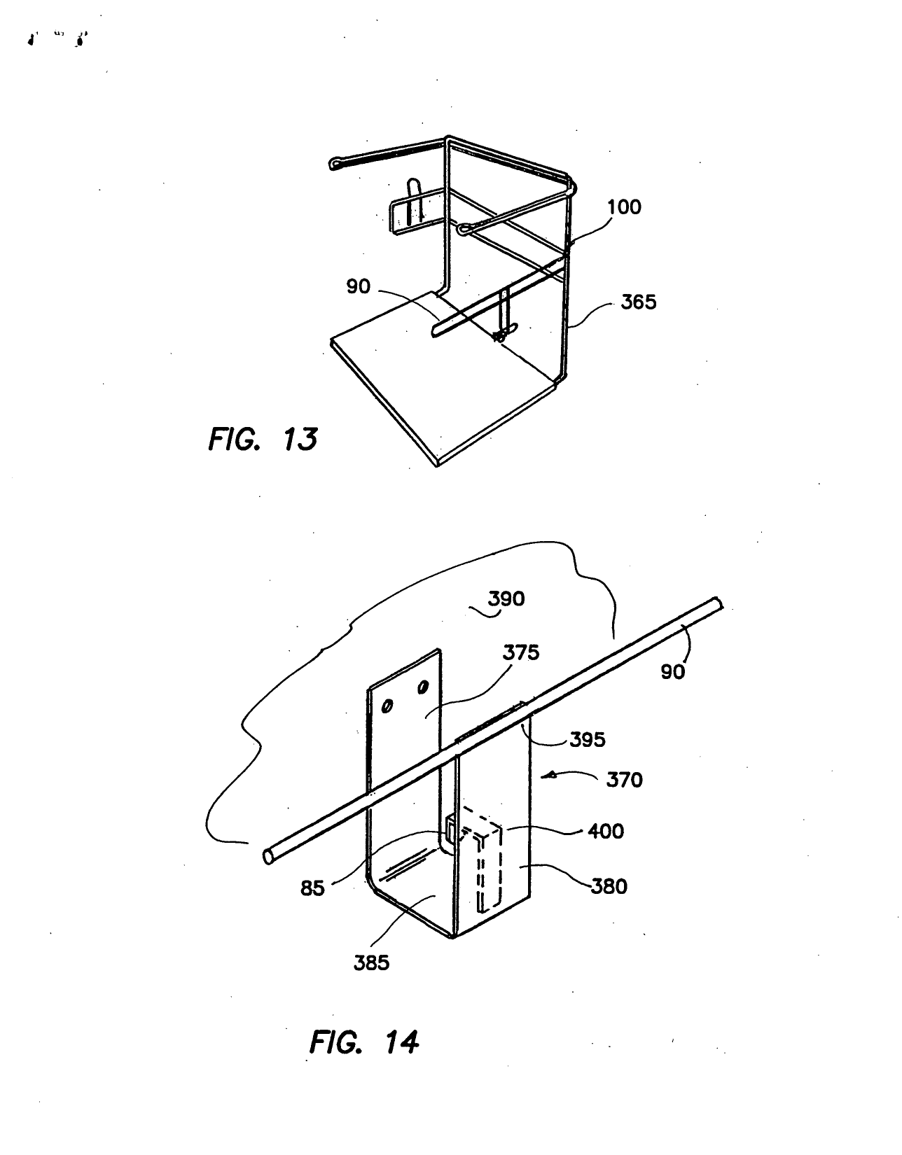

(22) In still a further variant, as illustrated in FIG. 13, the support bar 90 is attached at the second end 100 to another bag dispenser 365.

(23) In yet an further variant, as illustrated in FIG. 10, the spacing bracket 330 is attached to another bag dispenser 365.

(24) In another variant, as illustrated in FIG. 14, a U-shaped bracket 370 is provided. The bracket 370 has a first vertical side 375, a second vertical side 380 spaced from the first side 375 and a connecting lower portion 385. The first vertical side 375 has features for attaching the vertical side 375 to a vertical surface 390. The support bar 90 is attached orthogonally to an upper end 395 of the second vertical side 380. The downward pointing projection 85 is attached to the second vertical side 380 at a point 400 spaced downwardly from the support bar 90.

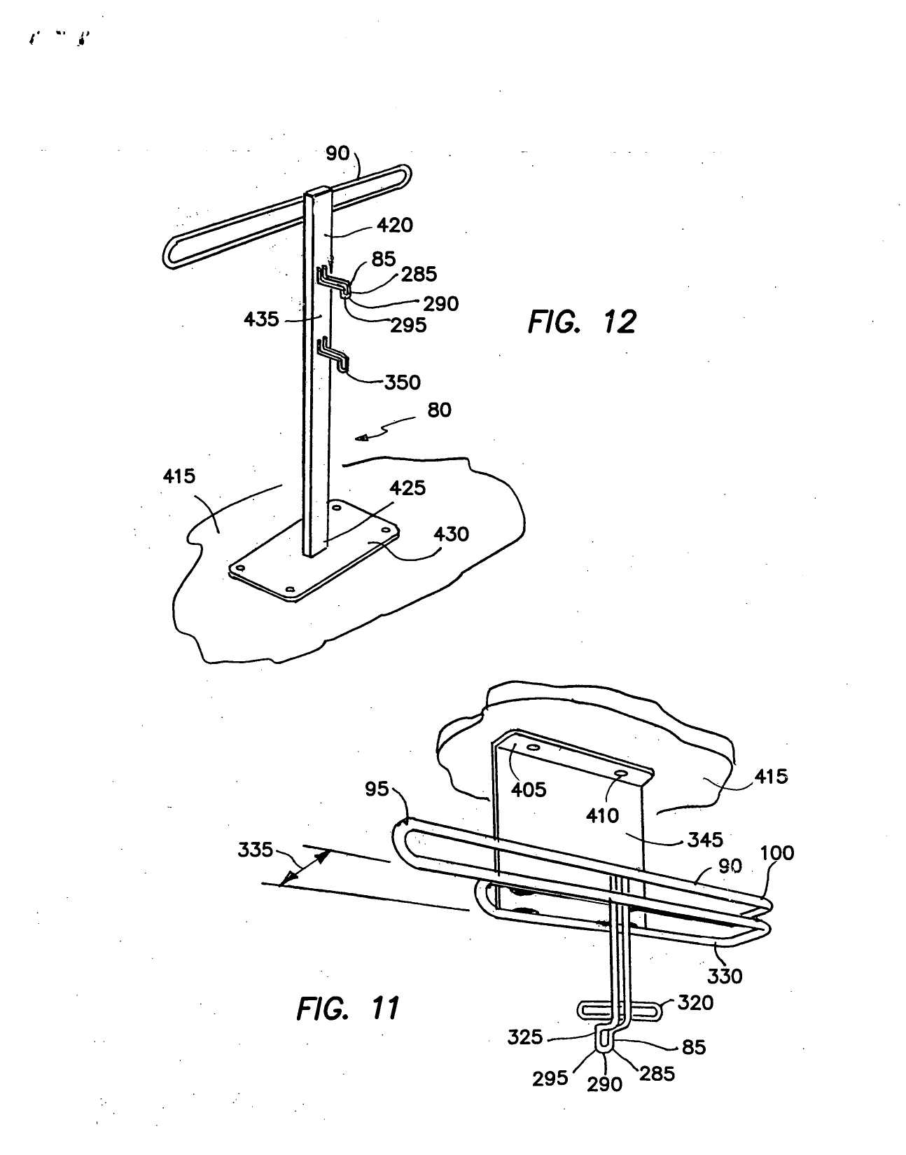

(25) In yet another variant, as illustrated in FIG. 11, the spacing bracket 330 is attached to an L-shaped bracket 405. The L-shaped bracket 405 extends above or below the support bar 90 and has at least one hole 410 through it for attachment to a horizontal surface 415.

(26) In still another variant of the invention, as illustrated in FIG. 12, the support bar 90 is centrally attached to a vertical member 420. The vertical member 420 is attached at a lower end 425 to a base 430 for securing the dispenser 80 to a horizontal surface 415. The vertical member 420 has at least one of the downward pointing projections 85, 350 attached to its front surface 435.

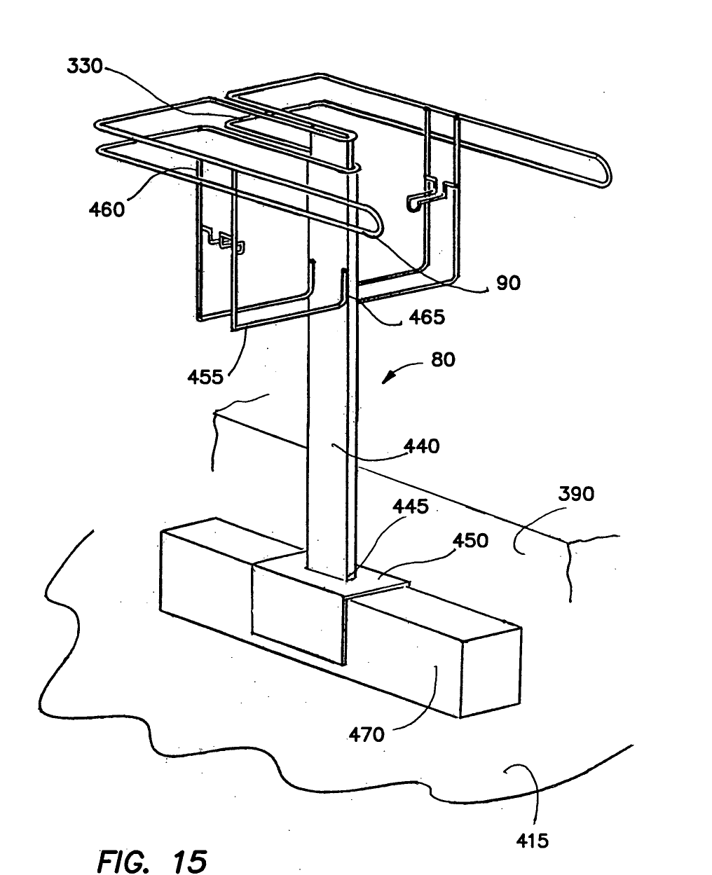

(27) In yet a further variant, as illustrated in FIG. 15, the spacing bracket 330 is attached to a vertical support 440. The vertical support 440 is attached at a lower 445 end to a base 450.

(28) In still a further variant, a reinforcing section 455 is provided. The reinforcing section 455 is attached to the support bar 90 at a first end 460 and attached to the vertical support 440 at a second end 465.

(29) In another variant of the invention, the base 450 is sized and shaped to secure the dispenser 80 to either a horizontal surface 415 or a vertical surface 390.

(30) In a final variant, the base 450 is sized and shaped to secure the dispenser to a railing 470.

The Center Tab Bags and Dispensers for Same Providing Easy Load Features 10 have been described with reference to particular embodiments. Other modifications and enhancements can be made without departing from the spirit and scope of the claims that follow.

1. A bag and dispenser combination, comprising:
a plurality of plastic bags, each of said bags having a front wall, a rear wall, first and second parallel linear side edges, a first predetermined width, front and rear top edges, an openable mouth and a bottom edge, said front and rear walls having at least one of a front tab and a rear tab;
said tab being disposed at at least one of said top edges and having an opening therethrough, said opening being sized, shaped and disposed for suspending said bag from a dispenser;
a dispenser, said dispenser comprising:
a downward pointing projection, said projection being sized and shaped to fit slidably through said opening in said tab;
a support bar, said support bar having first and second ends and being disposed horizontally above said projection; and
whereby, when said plurality of bags are suspended from said projection at said tab and disposed over said support bar, said bags will be positioned for individual dispensing.

2. A bag and dispenser combination as described in claim 1, wherein the bag is a T-shirt style bag comprising:
a front panel, said front panel having first and second parallel linear side edges, a top edge and a bottom edge;
a rear panel said rear panel having first and second parallel linear side edges, a top edge and a bottom edge;
two front gusset panels of a first predetermined dimension, each front gusset panel having a top edge, a bottom edge, first and second parallel side edges and being joined at said first side edge to one of the linear side edges of the front panel and extending from the top edge of the front panel to the bottom edge thereof;
two rear gusset panels of the first predetermined dimension, each rear gusset panel having a top edge, a bottom edge, first and second parallel side edges and being joined at said first side edge to one of the linear side edges of the rear panel and extending from the top edge of the rear panel to the bottom edge thereof;
each front gusset panel also being joined to a respective one of said rear gusset panels at said second side edge;
each of the front and rear gusset panels being folded inwardly relative to the front and the rear panels;
the top edges of the front panel, the rear panel, the front gusset panels and the rear gusset panels terminating in an upper seam;
the bottom edges of the front panel, the rear panel, the front gusset panels and the rear gusset panels terminating in a lower seam, said lower seam being perpendicular to the linear side edges of the front and rear panels; and
a U-shaped cut-out, said U-shaped cut-out being disposed in an upper portion of the bag and commencing at a first point along the upper seam spaced inwardly from said first linear side edge and extending to a second point along the upper seam spaced inwardly from said second linear side edge, said cut-out extending downwardly toward the lower seam, thereby forming an openable mouth and a pair of bag handles, said tab being centrally disposed on an edge of said openable mouth.

3. A bag and dispenser combination as described in claim 1, wherein said tab is attached to said openable mouth using a cut line such that as the bag is pulled from the dispenser, the tabs will be torn from the bag mouth and remain on the projection.

4. A bag and dispenser combination as described in claim 1, wherein said tab further comprises:
a rupturable feature, said rupturable feature connecting to said opening and extending toward a perimeter of said tab; and
whereby, when the bag is pulled from the dispenser, the rupturable feature will provide a connection between the opening and the perimeter, permitting the bag to be removed from the projection without leaving a portion of the tabs on said projection.

5. A bag and dispenser combination as described in claim 1, wherein said bags further comprise:
means for removably attaching an upper portion of said rear panel of a first bag to an upper portion of said front panel of a second, adjacent registered bag; and
whereby, when said first bag is pulled from said dispenser, said rear panel will pull said front panel of said second bag forward, causing said second bag to open.

6. A bag and dispenser combination as described in claim 5, wherein said means for removably attaching said upper portion of said rear panel of the first bag to said upper portion of said front panel of the second, adjacent registered bag is selected from the group comprising:
glue spotting, corona treatment, hot pinning, cold staking and compression.

7. A bag and dispenser combination as described in claim 1, wherein said projection comprises a downward facing hook.

8. A bag and dispenser combination as described in claim 7, wherein said downward facing hook further comprises a rounded feature at a lower end of said hook, said rounded feature designed to prevent injury and unwanted tearing of the bag tabs.

9. A bag and dispenser combination as described in claim 1, wherein said support bar has a length greater than said first predetermined width.

10. A bag and dispenser combination as described in claim 1, wherein said support bar has bag control features disposed at said first and second ends.

11. A bag and dispenser combination as described in claim 10, wherein said bag control features comprise upwardly angled projections, said projections being sized, shaped and disposed to prevent lateral movement of the bags.

12. A bag and dispenser combination as described in claim 10, wherein said bag control features comprise rounded ends, said rounded ends being sized, shaped and disposed to prevent lateral movement of the bags.

13. A bag and dispenser combination as described in claim 1, further comprising a tab stop, said tab stop being mounted to said downward pointing projection above a lower end of said projection and preventing upward movement of bag tabs beyond said tab stop.

14. A bag and dispenser combination as described in claim 1, wherein said support bar is attached at said second end to a spacing bracket, said spacing bracket disposing said support bar at a first predetermined distance outward from said bracket such that a bag pack will fit slidably between said bracket and said support bar.

15. A bag and dispenser combination as described in claim 14, wherein said downward pointing projection is attached to said spacing bracket.

16. A bag and dispenser combination as described in claim 14, wherein said downward pointing projection is attached to said support bar.

17. A bag and dispenser combination as described in claim 14, wherein said dispenser further comprises a mounting fixture, said mounting fixture being attached to said spacing bracket.

18. A bag and dispenser combination as described in claim 1, further comprising at least one additional downward pointing projection, said additional projection being disposed below said projection.

19. A bag and dispenser combination as described in claim 18, wherein said additional projection extends outwardly toward said support bar further than said projection.

20. A bag and dispenser combination as described in claim 1, wherein said support bar is attached at said second end to a horizontal surface mount and said downward pointing projection is attached to said support bar.

21. A bag and dispenser combination as described in claim 1, wherein said support bar is attached at said second end to a vertical surface mount and said downward pointing projection is attached to said support bar.

22. A bag and dispenser combination as described in claim 1, wherein said support bar is attached at said second end to another bag dispenser.

23. A bag and dispenser combination as described in claim 14, wherein said spacing bracket is attached to another bag dispenser.

24. A bag and dispenser combination as described in claim 1, further comprising:
a U-shaped bracket, said bracket having a first vertical side, a second vertical side spaced from said first side and a connecting lower portion;
said first vertical side having features for attaching said vertical side to a vertical surface;
said support bar being attached orthogonally to an upper end of said second vertical side; and
said downward pointing projection being attached to said second vertical side at a point spaced downwardly from said support bar.

25. A bag and dispenser combination as described in claim 14, wherein said spacing bracket is attached to an L-shaped bracket, said L-shaped bracket extending either of above and below said spacing bar and having at least one hole therethrough for attachment to a horizontal surface.

26. A bag and dispenser combination as described in claim 1, wherein said support bar is centrally attached to a vertical member, said vertical member being attached at a lower end to a base for securing said dispenser to a horizontal surface, said vertical member having at least one of said downward pointing projections attached to a front surface thereof.

27. A bag and dispenser combination as described in claim 16, wherein said spacing bracket is attached to a vertical support, said vertical support being attached at a lower end to a base.

28. A bag and dispenser combination as described in claim 27, further comprising a reinforcing means, said reinforcing means being attached to said support bar at a first end and said vertical support at a second end.

29. A bag and dispenser combination as described in claim 27, wherein said base is sized and shaped for securing said dispenser to either of a horizontal surface and a vertical surface.

30. A bag and dispenser combination as described in claim 27, wherein said base is sized and shaped to secure said dispenser to a railing.
